(19) United States
(12) Patent Application Publication
(10) Pub. No.: US 2025/0177994 A1
(43) Pub. Date: Jun. 5, 2025

(54) SHREDDER AND METHOD FOR CONTROLLING SHREDDER

(71) Applicant: SEIKO EPSON CORPORATION, Tokyo (JP)

(72) Inventors: Kiyoshi TSUJINO, Matsumoto (JP); Koichiro YOKOYAMA, Shiojiri (JP)

(21) Appl. No.: 18/961,558

(22) Filed: Nov. 27, 2024

(30) Foreign Application Priority Data
Dec. 1, 2023 (JP) 2023-203695

(51) Int. Cl. B02C 25/00; B02C 18/00

(52) U.S. Cl. CPC B02C 25/00; B02C 18/0007; B02C 2018/0046

(57) ABSTRACT

A shredder includes a shredding unit that shreds paper into paper pieces, a tank that stores the paper pieces, a weight sensor that is provided below the tank and that measures a weight of the paper pieces inside the tank, a processor of a control unit that calculates an environmental contribution value based on the weight of the paper pieces measured by the weight sensor, and a display that displays the environmental contribution value.

The present application is based on, and claims priority from JP Application Serial Number 2023-203695, filed Dec. 1, 2023, the disclosure of which is hereby incorporated by reference herein in its entirety.

### BACKGROUND

### 1. Technical Field

The present disclosure relates to a shredder and a method for controlling the shredder.

### 2. Related Art

In the related art, a shredder that shreds copy paper on which printing has been performed and that has become unnecessary, or the like is known. For example, JP-A-2015-136651 discloses a shredder including a waste paper container that contains shredded pieces.

However, in the shredder described in JP-A-2015-136651, when the shredded paper is reused, the degree of contribution to the environment is not clear. In recent years, while consideration to the environment has been emphasized, motivation for environmental conservation has become more important. The shredder users have had no means of knowing to what degree reusing of shredded documents contributes to environmental conservation when shredding unnecessary documents. The disclosure below has been proposed to solve the above-described problem.

### SUMMARY

A shredder of the present disclosure includes a shredding unit that shreds paper into paper pieces, a tank that stores the paper pieces, a weight sensor that is provided below the tank and that measures a weight of the paper pieces inside the tank, a processor that calculates an environmental contribution value based on the weight of the paper pieces measured by the weight sensor, and a display that displays the environmental contribution value.

In a method for controlling a shredder of the present disclosure, the shredder includes a shredding unit that shreds paper into paper pieces, a tank that stores the paper pieces, a weight sensor that measures a weight of the paper pieces inside the tank, a processor, and a display, and the method for controlling the shredder includes a first step of measuring the weight of the paper pieces by the weight sensor, a second step of calculating, by the processor, an environmental contribution value based on the weight of the paper pieces measured by the weight sensor, and a third step of displaying the environmental contribution value on the display.

### BRIEF DESCRIPTION OF THE DRAWINGS

FIG. 1 is a perspective view illustrating an external appearance of a shredder according to an embodiment.

FIG. 2 is a perspective view illustrating an external appearance of the shredder when a door portion is open.

FIG. 3 is a sectional view illustrating an inside configuration of the shredder.

FIG. 4 is a flow diagram illustrating a method for controlling the shredder.

FIG. 5 is a view illustrating a display example of an environmental contribution value on a display.

FIG. 6 is a schematic view illustrating a waste paper recycling flow using the shredder and a paper manufacturing apparatus.

### DESCRIPTION OF EMBODIMENTS

In the following embodiment, a shredder 1 that shreds paper such as waste paper on which printing has been performed and that has become used and a method for controlling the shredder 1 will be exemplified and described with reference to the drawings. In the respective figures below, X, Y and Z axes, which are coordinate axes orthogonal to each other, are given where necessary, a direction indicated by each arrow is a positive direction, and a direction opposite to the positive direction is a negative direction. When the shredder 1 is set on a horizontal surface, the Z axis is a virtual axis extending in a vertical direction. A +Z direction is upward, and a −Z direction is downward.

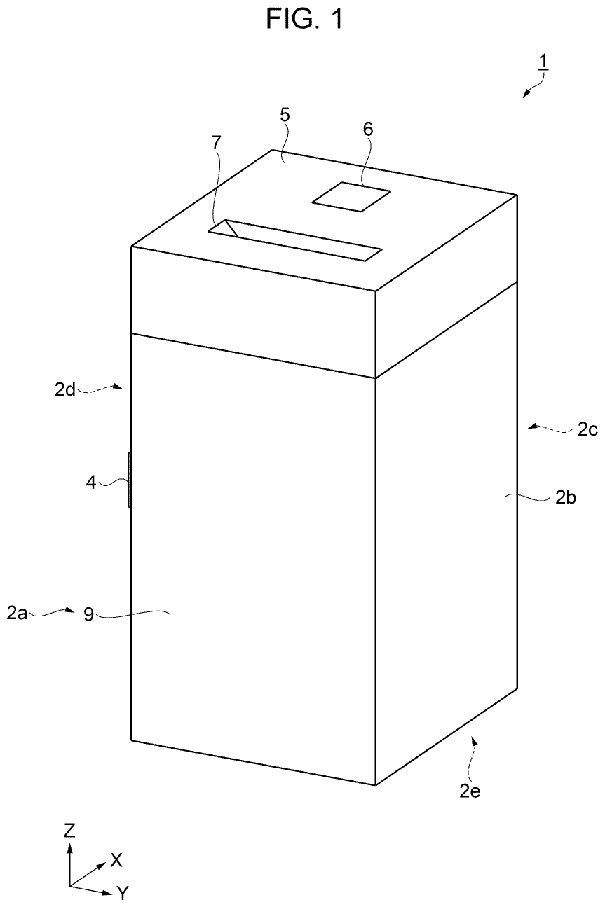

As illustrated in FIG. 1, the shredder 1 according to the present embodiment has a substantially rectangular parallelepiped shape. The shredder 1 has a housing including a top surface 5 and a bottom surface 2e facing each other in an up and down direction, and four side surfaces 2a, 2b, 2c, and 2d. The side surfaces 2a, 2b, 2c, and 2d each have a rectangular shape whose long side extends along the Z axis.

Each constituent of the shredder 1 described later is housed in the above-described housing. A user of the shredder 1 faces the side surface 2a facing in a −X direction when shredding paper or the like. In the following description, the user of the shredder 1 may also be simply referred to as a user.

The shredder 1 includes a display 6. The display 6 is disposed in a +X direction of the top surface 5. The display 6 displays various information such as an operation status and an operation manual of the shredder 1. In particular, the display 6 displays an environmental contribution value described later.

The display 6 may also serve as an operation unit that receives various instructions to the shredder 1 from the user. The display 6 is, for example a touch panel liquid crystal display device. Note that the display 6 is not limited to having a configuration in which the display 6 also serves as an operation unit. The operation unit may be installed separately from the display 6.

A charging port 7 is disposed in the −X direction of the top surface 5. The charging port 7 is an opening through which paper to be shredded is inserted. The paper inserted from the charging port 7 moves to a shredding unit described later inside the above-described housing.

A door portion 9 constituting part of the side surface 2a is disposed on the side surface 2a. The door portion 9 has a substantially rectangular shape when viewed in the −X direction and has a long side extending along the Z axis. The door portion 9 is a substantially plate-like member. The door portion 9 can be opened with the long side in a +Y direction as a fulcrum.

A handle portion 4 is provided on the long side of the door portion 9 in a −Y direction. When the handle portion 4 is held by hand, and the door portion 9 is pulled substantially in the −X direction, the door portion 9 can be opened.

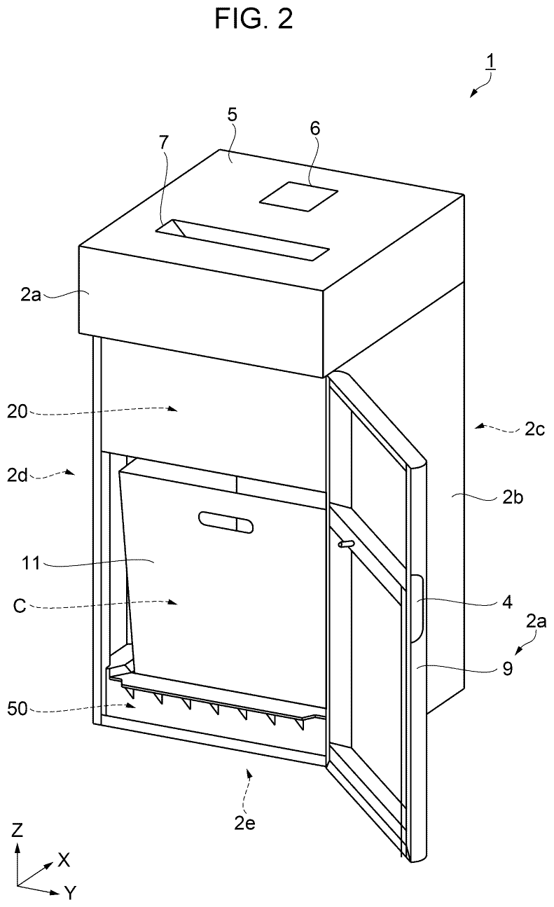

As illustrated in FIG. 2, the shredder 1 includes a shredding unit 20, a tank 11, a weight sensor 50, and a control unit 40 described later inside the above-described housing.

The shredding unit 20 shreds paper into paper pieces C. The shredding unit 20 is disposed in an upper portion inside the housing of the shredder 1. The paper pieces C fall from the shredding unit 20 to the tank 11 by gravity.

The tank 11 stores the paper pieces C. The tank 11 is disposed in an inside space of the above-described housing below the shredding unit 20. The tank 11 is a box having a rectangular parallelepiped shape whose upper portion is open. The tank 11 is made of, for example, resin.

The tank 11 can be attached to and removed from the shredder 1. When the door portion 9 is opened, the tank 11 can be removed. The user can collect the paper pieces C from the tank 11 after opening the door portion 9 and taking out the tank 11 from the shredder 1.

The weight sensor 50 measures the weight of paper pieces inside the tank 11 mounted on the weight sensor 50. The weight sensor 50 is provided directly above the bottom surface 2e and below the tank 11.

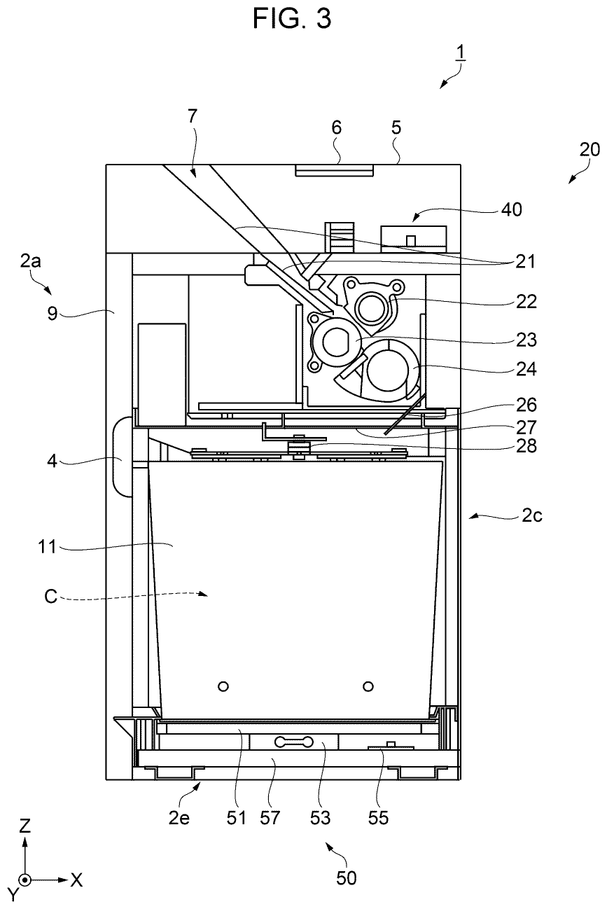

As illustrated in FIG. 3, the shredding unit 20 has a first slope portion 21, a first vertical blade 22, a second vertical blade 23, a horizontal blade 24, a second slope portion 26, a top plate 27, and a stirring portion 28.

In the shredding unit 20, the first slope portion 21, the first vertical blade 22 and the second vertical blade 23, the horizontal blade 24, and the second slope portion 26 are disposed above the top plate 27 in the above-described order. The paper to be shredded sequentially moves from the charging port 7 to the first slope portion 21, the first vertical blade 22 and the second vertical blade 23, the horizontal blade 24, the second slope portion 26, and the stirring portion 28.

The top plate 27 is disposed above the tank 11. The stirring portion 28 is disposed between the tank 11 and the top plate 27. The control unit 40 is disposed directly above the shredding unit 20 and directly below the top surface 5.

The charging port 7 has an elongated rectangular shape along the Y axis. A dimension of the charging port 7 along the Y axis corresponds to, for example, a width dimension of the paper to be shredded. The paper to be shredded enters the shredder 1 from the charging port 7 and slips down along the first slope portion 21 by gravity so as to move to the shredding unit 20.

In the first slope portion 21, a paper detection sensor (not illustrated) is disposed. The paper detection sensor detects the existence of the paper inserted from the charging port 7. The paper detection sensor is electrically connected to the control unit 40 and transmits the detection results to the control unit 40.

The first slope portion 21 extends from the charging port 7 to the first vertical blade 22 and the second vertical blade 23. At an end of the first slope portion 21, the first vertical blade 22 and the second vertical blade 23 are disposed. The paper to be shredded reaches a portion between the first vertical blade 22 and the second vertical blade 23 via the first slope portion 21.

The first vertical blade 22 and the second vertical blade 23 form a pair, each of the first vertical blade 22 and the second vertical blade 23 has a substantially columnar shape, and a height direction of the column extends along the Y axis. Each of the first vertical blade 22 and the second vertical blade 23 is rotated around an axis along the Y axis by driving of a drive motor (not illustrated). Each of the first vertical blade 22 and the second vertical blade 23 includes a plurality of blades arranged in a direction along the Y axis. The paper is shredded by the first vertical blade 22 and the second vertical blade 23 in a moving direction and becomes elongated strip-shaped paper pieces. The paper pieces move toward the horizontal blade 24.

The horizontal blade 24 has a substantially columnar shape, and a height direction of the column extends along the Y axis. The horizontal blade 24 is rotated round an axis along the Y axis by driving of a drive motor (not illustrated). The horizontal blade 24 shreds the strip-shaped paper pieces, in a direction intersecting with the moving direction, into the paper pieces C. When the paper to be shredded is a confidential document, the paper pieces C are preferably shredded by the first vertical blade 22 and the second vertical blade 23, and the horizontal blade 24 into a such state that confidential information management is unnecessary.

The second slope portion 26 is disposed below the horizontal blade 24. The paper pieces C fall by gravity and move toward the stirring portion 28 while being guided by the second slope portion 26.

The stirring portion 28 disperses, in air, the paper pieces C slipping down on the second slope portion 26 and causes the paper pieces C to fall into the tank 11. The stirring portion 28 is a propeller-like member. The stirring portion 28 rotates around an axis along the Z axis by driving of a drive motor (not illustrated). The paper pieces C get caught in the rotation of the stirring portion 28 and are dispersed in air in an upper portion of the tank 11. As a result, inside the tank 11, the paper pieces C accumulate while being scattered and not concentrating directly below the second slope portion 26.

The weight sensor 50 has a pedestal member 51, a load cell 53, a circuit substrate 55, and a base member 57. In the weight sensor 50, from an upper side to a lower side, the pedestal member 51, the load cell 53 and the circuit substrate 55, and the base member 57 are disposed in this order.

The pedestal member 51 is a substantially flat plate-like member on which the tank 11 is mounted. A lower side of the pedestal member 51 is supported by the load cell 53 so as to be floated from other constituents such as the base member 57. A load of the tank 11 mounted on the pedestal member 51 and the paper pieces C is applied only to the load cell 53.

A lower side of the load cell 53 is supported by the base member 57, and an upper side of the load cell 53 is mounted with the pedestal member 51. The load cell 53 is disposed at a center of the base member 57 in a direction along the X axis. The load cell 53 measures the weight of the paper pieces C inside the tank 11 from distortion generated by a load applied from above. A known type of load cell can be adopted to the load cell 53. In the shredder 1, a beam type is adopted as the load cell 53.

The weight measuring mechanism of the weight sensor 50 is not limited to the load cell 53. Examples of the weight measuring mechanism other than the load cell 53 include, for example, a spring balance and an electromagnetic balance.

The circuit substrate 55 is electrically connected to the control unit 40 and the load cell 53. The circuit substrate 55 is disposed in the +X direction of the load cell 53 and is attached to the base member 57 in a lower portion. The circuit substrate 55 transmits data of the measured weight of the paper pieces to the control unit 40 as an electric signal.

The base member 57 is supported by a structure member (not illustrated) of the shredder 1 in a lower portion and supports the load cell 53 and the circuit substrate 55 in an upper portion. The base member 57 extends along the X axis. The base member 57 is, for example, a metal plate on which sheet metal processing is performed.

The control unit 40 is electrically connected to the above-described constituents of the shredding unit 20, the display 6, the weight sensor 50, and the like. The control unit 40 comprehensively controls operation of these constituents.

The control unit 40 includes a storing unit including a central processing unit (CPU), a random access memory (RAM), a read only memory (ROM), and the like. The storing unit stores various programs that control the shredder 1. The control unit 40 may include hardware (application specific integrated circuit: ASIC) dedicated for executing at least part of processing of various processing.

The control unit 40 includes one or more processors that operate according to a computer program (software). The processor calculates the environmental contribution value based on the weight of the paper pieces measured by the weight sensor 50.

The processor includes a CPU and a memory such as a RAM and a ROM. The memory stores a program code or a command configured to cause the CPU to execute processing. The memory, that is, a computer-readable medium includes any available media that can be accessed by a general purpose or a special purpose computer. The processor controls operation of each constituent of the shredder 1 via a controller or the like.

Note that the shredder 1 may also include an optical sensor that detects the volume of the paper pieces C stored in the tank 11.

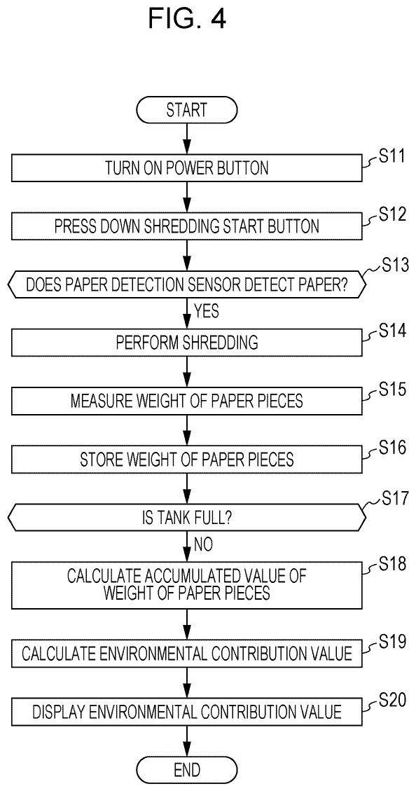

As illustrated in FIG. 4, the method for controlling the shredder 1 includes step S11 to step S20. Step S11 to step S20 relate to measurement of the weight of the paper pieces and calculation and display of the environmental contribution value. In addition to the step S11 to step S20, a known controlling method may be adopted to the method of controlling the shredder 1. Note that in the following description, FIG. 3 will also be referred to, in addition to FIG. 4.

In step S11, a power button is turned on by the user. The power button may be included in the display 6 or may be installed independently of the display 6. Then, the process proceeds to step S12.

In step S12, a shredding start button is pressed down by the user. Similarly to the power button, the shredding start button is provided on the display 6 or the like. The user inserts paper to be shredded into the shredder 1 from the charging port 7 around the time when an instruction to start shredding is given. Then, the process proceeds to step S13.

In step S13, the control unit 40 determines whether or not there is the paper inserted from the charging port 7. When the above-described paper detection sensor detects paper, the control unit 40 determines that there is the paper to be shredded and causes the process to proceed to step S14.

In step S14, paper shredding is performed. The paper becomes the paper pieces C, is dispersed by the stirring portion 28, and accumulates inside the tank 11. Step S14 continues until the paper detection sensor does not detect paper, that is, until there is no paper to be shredded. Then, the process proceeds to step S15.

In step S15, the weight sensor 50 measures the weight of the paper pieces inside the tank 11. Step S15 corresponds to a first step of the method for controlling the shredder of the present disclosure. The weight of the paper pieces is measure by, for example, 0.01 kg unit. Data of the weight of the paper pieces is transmitted from the weight sensor 50 to the control unit 40. Then, the process proceeds to step S16.

In step S16, in the control unit 40, the weight of the paper pieces that is measured and received in step S15 is stored. Then, the process proceeds to step S17.

In step S17, whether or not the tank 11 is full of the paper pieces C is determined. Specifically, the control unit 40 determines whether or not the weight of the paper pieces has reached a predetermined threshold based on the data of the weight of the paper pieces transmitted from the weight sensor 50.

When the control unit 40 determines that the tank 11 is full, the control unit 40 adds the weight of the paper pieces to an accumulated value of the weight of the paper pieces and also urges the user to collect the paper pieces C inside the tank 11 through the display 6 or the like. When the control unit 40 determines that the tank 11 is not full, the control unit 40 causes the process to proceed to step S18.

In step S18, the control unit 40 calculates the accumulated value of the weight of the paper pieces. Here, the accumulated value of the weight of the paper pieces indicates the weight of the paper pieces of all paper that has been shredded since the beginning of the use of the shredder 1. Specifically, the accumulated value of the weight of the paper pieces is the sum of a total value of the weight of the paper pieces that is stored every time the paper pieces C inside the tank 11 are collected and the latest weight of the paper pieces until the tank 11 becomes full. The weight of the paper pieces before the tank 11 becomes full after the paper pieces C inside the tank 11 have been collected is renewed every time the weight of the paper pieces is measured and is stored by the control unit 40. Then the process proceeds to step S19.

In step S19, the processor of the control unit 40 calculates the accumulated value of the weight of the paper pieces from the weight of the paper pieces measured by the weight sensor 50 and the above-described total value. Based on the above-described calculated accumulated value, the environmental contribution value is calculated. Step S18 and step S19 correspond to a second step of the method for controlling the shredder of the present disclosure.

The environmental contribution value is the number of paper sheets to be manufactured and the equivalent number of trees. The environmental contribution value is not limited to the above-described numbers and may be, for example, the carbon dioxide reduction amount, the water consumption reduction amount, or the like.

The number of paper sheets to be manufactured is the predicted number of paper sheets that can be manufactured when the paper pieces C are used and recycled into paper. The size of the paper sheets to be manufactured is, for example, an A4 size. Specifically, the number of paper sheets to be manufactured is calculated by the equation described below.

The total value of the weight of the paper pieces that is stored every time the paper pieces C inside the tank 11 are collected is A [kg]. The weight of the paper pieces until the tank 11 becomes full, that is, the weight of the paper pieces most recently measured is B [kg]. The above-described sum is obtained from A+B and is the accumulated value of the weight of paper pieces calculated in step S18.

In a paper manufacturing apparatus used for recycling the paper pieces C, the weight of the paper to be manufactured per sheet is a [kg], and the utilization efficiency of the paper pieces C is b [%]. The utilization efficiency b is calculated after color materials, impurities, or the like unnecessary for recycling the paper pieces C are subtracted.

The number of paper sheets to be manufactured is calculated from the equation (A+B)*b*0.01/a.

The equivalent number of trees is an index indicating the number of trees equivalent to the accumulated value of the weight of paper pieces when the paper pieces C are used and recycled into paper. The equivalent number of trees is also the number of trees that do not have to be cut down when the paper pieces C are reused.

The waste paper use rate is d [%]. The waste paper use rate d is cited from Paper Recycling Handbook issued by Public Interest Organization Paper Recycling Promotion Center. The number of paper sheets that can be manufactured from one tree is e. The number of paper sheets that can be manufactured e is cited from a document issued by Japan Paper Association.

The equivalent number of trees is calculated from the equation (A+B)*b/{e*a*(100+d)}.

Specifically, for example, when the accumulated value of the weight of paper pieces A+B is 50 kg, the number of paper sheets to be manufactured is approximately 7,000, and the equivalent number of trees is approximately 0.6. Then, the process proceeds to step S20.

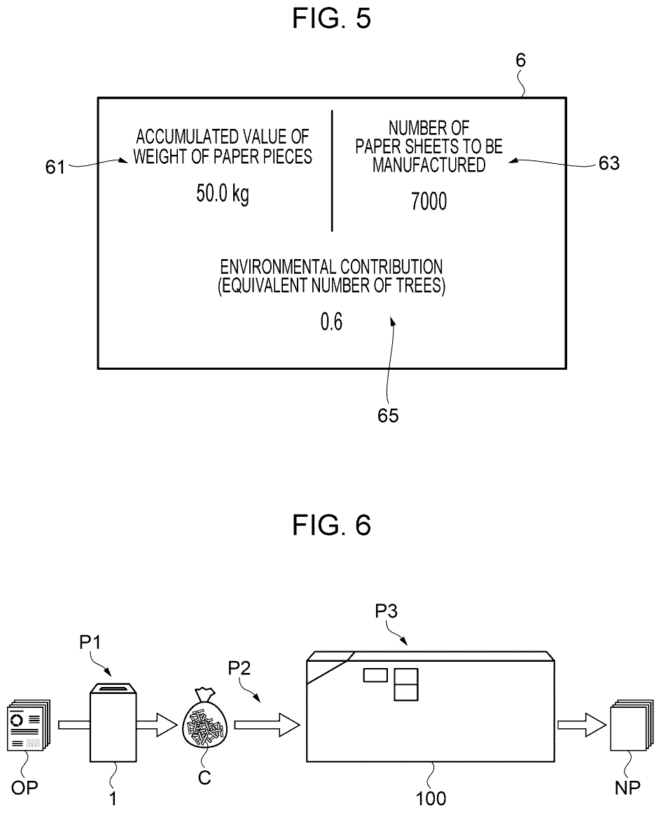

In step S20, the control unit 40 causes the display 6 to display the environmental contribution value. Step S20 corresponds to a third step of the method for controlling the shredder of the present disclosure. A display example of the environmental contribution value on the display 6 is illustrated in FIG. 5.

As illustrated in FIG. 5, the display 6 displays the respective values in regions 61, 63, and 65 when displaying the environmental contribution value. The region 61 displays the accumulated value of the weight of the paper pieces A+B [kg]. The region 63 displays the number of paper sheets to be manufactured of the environmental contribution value. The region 65 displays the equivalent number of trees of the environmental contribution value. As a result, the user can visually recognize the environmental contribution value.

FIG. 4 is returned, and steps S18 and S19, which are the second step, and step S20, which is the third step, are performed after the paper is shredded by the shredding unit 20 in step S14. The user can know the environmental contribution value after the shredding operation. As described above, from step S11 to step S20, paper shredding is performed, and then the environmental contribution value is displayed.

As illustrated in FIG. 6, the shredder 1 may be operated in combination with a paper manufacturing apparatus 100. As a first stage P1, waste paper OP such as unnecessary copy paper is shredded into the paper pieces C by the shredder 1. Next, as a second stage P2, the paper pieces C are accumulated in the paper manufacturing apparatus 100. Next, as a third stage P3, a regenerated sheet NP is manufactured using the paper pieces C in the paper manufacturing apparatus 100.

A known paper manufacturing machine can be adopted to the paper manufacturing apparatus 100. For example, when a confidential document or the like that has become unnecessary is shredded, as the waste paper OP, by the shredder 1 installed in an office, the paper manufacturing apparatus 100 is installed on the same floor or in the same building as the above-described office. As a result, in addition to reduction of labor such as transport accompanied by collection of the paper pieces C, or the like, the regenerated sheet NP can be used at the above-described office.

A relatively small paper manufacturing machine is more suitable to the paper manufacturing apparatus 100 than is an industrial paper manufacturing machine. Examples of the small paper manufacturing machine include a dry type office paper manufacturing machine PaperLab (registered trademark) manufactured by Seiko Epson Corporation, for example.

According to the present embodiment, the following effects can be obtained.

The user can know the degree of contribution to the environment. Since the effects of reusing shredded paper are visualized, the user can realize the contribution to the environment and is motivated to work for environmental conservation.

What is claimed is:

1. A shredder comprising:
a shredding unit that shreds paper into paper pieces;
a tank that stores the paper pieces;
a weight sensor that is provided below the tank and that measures a weight of the paper pieces inside the tank;
a processor that calculates an environmental contribution value based on the weight of the paper pieces measured by the weight sensor; and
a display that displays the environmental contribution value.

2. A method for controlling a shredder, the shredder including a shredding unit that shreds paper into paper pieces, a tank that stores the paper pieces, a weight sensor that measures a weight of the paper pieces inside the tank, a processor, and a display, the method for controlling the shredder, comprising:
a first step of measuring the weight of the paper pieces by the weight sensor;
a second step of calculating, by the processor, an environmental contribution value based on the weight of the paper pieces measured by the weight sensor; and
a third step of displaying the environmental contribution value on the display.

3. The method for controlling a shredder according to claim 2, wherein
the second step and the third step are performed after shredding by the shredding unit.

4. The method for controlling a shredder according to claim 2, wherein
in the second step, an accumulated value of the measured weight of the paper pieces is calculated, and the environmental contribution value is calculated based on the calculated accumulated value.
